(19) United States
(12) Patent Application Publication
(10) Pub. No.: US 2011/0011775 A1
(43) Pub. Date: Jan. 20, 2011

(54) METHODS AND APPARATUSES FOR PURIFYING CARBON FILAMENTARY STRUCTURES

(76) Inventors: Frédéric LAROUCHE, L'Ile-Bizard (CA); Olivier SMILJANIC, Montreal (CA); Barry L. STANSFIELD, St-Bruno (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/893,758

(22) Filed: Sep. 29, 2010

Related U.S. Application Data
(63) Continuation of application No. 11/387,804, filed on Mar. 24, 2006.
(60) Provisional application No. 60/664,952, filed on Mar. 25, 2005.

(51) Int. Cl. B07B 7/00; B07B 7/08; B03C 1/30

(52) U.S. Cl. 209/133; 977/742

(57) ABSTRACT

There is provided method for treating a gaseous phase comprising carbon filamentary structures having metal particles attached or linked thereto, for separating at least a portion of said carbon filamentary structures from said metal particles. The method comprises submitting said gaseous phase to a disturbance generated by an electric field, a magnetic field, ultrasounds, a turbulent gas stream, or combinations thereof, thereby reducing the amount of carbon filamentary structures having metal particles attached or linked thereto.

### CROSS-REFERENCE TO RELATED APPLICATION

The present application is a continuation of U.S. Non-provisional application Ser. No. 11/387,804 filed on Mar. 24, 2006 and which claims priority on U.S. provisional application No. 60/664,952 filed on Mar. 25, 2005. These two documents are incorporated herein by reference in their entirety.

### FIELD OF THE INVENTION

The present invention relates to improvements in the field of carbon filamentary structures production. More particularly, the invention relates to improved methods and apparatuses for purifying carbon filamentary structures such as carbon fibres, single-wall carbon nanotubes or multi-wall carbon nanotubes.

### BACKGROUND OF THE INVENTION

Carbon nanotubes are available either as multi-wall or single-wall nanotubes. Multi-wall carbon nanotubes have exceptional properties such as excellent electrical and thermal conductivities. They have applications in numerous fields such as storage of hydrogen (C. Liu, Y. Y. Fan, M. Liu, H. T. Cong, H. M. Cheng, M. S. Dresselhaus, Science 286 (1999), 1127; M. S. Dresselhaus, K. A Williams, P. C. Eklund, MRS Bull. (1999), 45) or other gases, adsorption heat pumps, materials reinforcement or nanoelectronics (M. Menon, D. Srivastava, Phy. Rev. Lett. 79 (1997), 4453). Single-wall carbon nanotubes, on the other hand, possess properties that are significantly superior to those of multi-wall nanotubes. For any industrial application such as storage or material reinforcement, the amount of single-wall carbon nanotubes produced must be at least a few kilograms per day. For most of the applications, they must be purified since they are often associated with impurities such as metallic particles, usually surrounded by graphitic shells, or amorphous carbon which can considerably diminish their properties.

Nowadays, the methods used for purifying single-wall carbon nanotubes use a chemical oxidizer. Also the methods frequently used comprise the step of heating to about 200° C. (Chiang et al., J. Phys. Chem. B, 105 (2001) 8297 and Zhou et al., Chem. Phys. Lett., 350 (2001) 6.). Such a treatment causes the magnetic metal particles to be oxidized. Thus, the magnetic metal particles in their oxide form are bigger which eventually causes breaking or cracking of graphite shells having magnetic metal particles trapped therein. Then, the oxidized magnetic metal particles are dissolved by means of concentrated acid as HCl, H₂SO₄ or HNO₃. Finally, the nanotubes are heated to about 1150° C. so as to remove the amorphous carbon. Such a method of purifying nanotubes has a major drawback since the nanotubes can be functionalized or even be damaged. It is also a time consuming, polluting and costly method.

Thiên-Nga et al. (Nano Letters 2002, vol. 2, No. 12, 1349-1352) describe a method of mechanical purification of single-wall carbon nanotubes by removing therefrom ferromagnetic particles used for the catalytic growth of the nanotubes. In this method, the single-wall carbon nanotubes are dispersed in a solvent (such as toluene, N,N-dimethyl formamide or nitric acid) and inorganic particles (such as nanoparticles of zirconium oxide, diamond, ammonium chloride or calcium carbonate) are added to the suspension. The slurry thus obtained is then treated in an ultrasonic bath so as to cause ferromagnetic particles to be mechanically removed from their graphitic shell. Then, the magnetic particles are trapped with permanent magnetic poles, and a further chemical treatment is carried out on the nanotubes. The use of a liquid phase in the purification process can be time consuming since several steps such as filtration and drying are required.

Another major drawback in the synthesis of carbon nanotubes is that the methods that have been proposed so far are not continuous or in situ. In fact, to obtain a continuous method of producing carbon nanotubes, the synthesis and the depositing and/or purification must be ideally carried out in a continuous manner and/or integrated to the synthesis process. Moreover, in several proposed solutions, the produced carbon nanotubes are generated, isolated, manipulated and then purified. Therefore, several tasks and steps are required before obtaining a sufficient purity.

### SUMMARY OF THE INVENTION

According to one aspect of the present invention, there is provided a method for treating a gaseous phase comprising carbon filamentary structures having metal particles attached or linked thereto, for separating at least a portion of the carbon filamentary structures from the metal particles. The method comprises submitting the gaseous phase to a disturbance, thereby reducing the amount of carbon filamentary structures having metal particles attached or linked thereto.

According to another aspect of the present invention, there is provided a method for treating carbon filamentary structures having metal particles attached or linked thereto, for separating the carbon filamentary structures from the magnetic metal particles. The method comprises the steps of:

a) providing a gaseous phase comprising the carbon filamentary structures and the magnetic metal particles; and

b) submitting the gaseous phase to a disturbance so as to cause the carbon filamentary structures to become substantially physically separated from the magnetic metal particles.

It was found that such methods are very useful for reducing the amount of carbon filamentary structures, which are linked or attached to metal particles. In fact, such methods permit to physically separate the carbon filamentary structure from the metal particle, for at least a portion of the totality of carbon filamentary structures contaminated with the metal particles. By submitting a gaseous phase to such a treatment, at least a portion of the carbon filamentary structures that are attached or linked to a metal will be separated from the metal. The metal particles treated with such a methods can be magnetic metal particles as well as non-magnetic metal particles.

According to another aspect of the invention, there is provided a method for purifying carbon filamentary structures contaminated with magnetic metal particles. The method comprises submitting a gaseous phase comprising the carbon filamentary structures contaminated with magnetic metal particles, to an inhomogeneous magnetic field for at least partially trapping the magnetic metal particles, thereby reducing the amount of the magnetic metal particles present in the gaseous phase.

According to another aspect of the present invention, there is provided a method for purifying carbon filamentary structures contaminated with magnetic metal particles. The method comprises the steps of:

a) providing a gaseous phase comprising the carbon filamentary structures and the magnetic metal particles, the carbon filamentary structures being substantially physically separated from the magnetic metal particles;

b) submitting the gaseous phase to an inhomogeneous magnetic field so as to substantially trap the magnetic metal particles, thereby reducing the amount of the magnetic metal particles in the gaseous phase.

It was found that the latter two methods are effective for purifying carbon filamentary structures. It was also found that such purification techniques carried in gaseous phase have several considerable advantages since the carbon filamentary structures can be purified in situ or directly after their synthesis, without requiring any step or task between the synthesis and the purification. In fact, the carbon filamentary structures that are preferably obtained from a gas phase synthesis such as a plasma torch are already in a gaseous phase and thus, the purification can be carried out directly without the necessity of recovering them and then treating them so as to remove the impurities. Such methods thus permit to carry out the synthesis and purification of carbon filamentary structures in a single sequence or in a “one-pot” manner. Such methods can also be applied to carbon filamentary structures that are produced by other methods than a gas phase synthesis. In fact, carbon filamentary structures in solid or powder form can be mixed with a gas in order to obtain a gaseous phase and then, such a gaseous phase can be treated with the methods previously mentioned.

According to another aspect of the present invention, there is provided a method for purifying carbon filamentary structures contaminated with magnetic metal particles. The method comprises treating a gaseous phase comprising the carbon filamentary structures contaminated with magnetic metal particles, with or without a disturbance for separating at least a portion of the carbon filamentary structures from the magnetic metal particles; and with an inhomogeneous magnetic field for at least partially trapping the magnetic metal particles, thereby reducing the amount of the magnetic metal particles present in the gaseous phase.

According to another aspect of the present invention, there is provided a method for purifying carbon filamentary structures contaminated with magnetic metal particles. The method comprises submitting a gaseous phase comprising the carbon filamentary structures contaminated with magnetic metal particles, optionally to a disturbance for separating at least a portion of the carbon filamentary structures from the magnetic metal particles; and to an inhomogeneous magnetic field for at least partially trapping the magnetic metal particles, thereby reducing the amount of the magnetic metal particles present in the gaseous phase.

According to another aspect of the present invention, there is provided a method for purifying carbon filamentary structures contaminated with magnetic metal particles. The method comprises the steps of:

a) providing a gaseous phase comprising the carbon filamentary structures having the magnetic metal particles attached or linked thereto;

b) submitting the gaseous phase to a disturbance so as to cause the carbon filamentary structures to become substantially physically separated from the magnetic metal particles; and

c) submitting the gaseous phase obtained in step (b) to an inhomogeneous magnetic field so as to substantially trap the magnetic metal particles, thereby reducing the amount of the magnetic metal particles in the gaseous phase.

It was found that by using the latter three methods purification of the carbon filamentary structures was carried out efficiently and rapidly. In fact, it was observed that when the carbon filamentary structures are first submitted to a disturbance and then to the inhomogeneous magnetic field, superior results were obtained i.e. a higher purity was observed. In fact, it is believed, without being bounded to such an explanation, that such better results are obtained since the treatment with the disturbance permits to obtain a higher content or proportion, in the gaseous phase, of metal particles that are not attached or linked to carbon filamentary structures. Thus, the disturbance permits to increase the efficiency of the purification carried out with the inhomogeneous magnetic field.

According to another aspect of the present invention, there is provided a method for purifying carbon filamentary structures contaminated with magnetic metal particles. The method comprises recovering the carbon filamentary structures from a gaseous phase including carbon filamentary structures contaminated with magnetic metal particles, wherein the gaseous phase was previously treated with or without a disturbance in order to reduce the amount of carbon filamentary structures having magnetic metal particles attached or linked thereto, present in the gaseous phase; and with an inhomogeneous magnetic field for at least partially trapping the magnetic metal particles, thereby reducing the amount of the magnetic metal particles present in the gaseous phase.

According to another aspect of the present invention, there is provided a method for purifying carbon filamentary structures contaminated with magnetic metal particles. The method comprises:
treating a gaseous phase comprising the carbon filamentary structures contaminated with magnetic metal particles, with or without a disturbance in order to reduce the amount of carbon filamentary structures having magnetic metal particles attached or linked thereto, present in the gaseous phase;
submitting the gaseous phase to an inhomogeneous magnetic field for at least partially trapping the magnetic metal particles, thereby reducing the amount of the magnetic metal particles present in the gaseous phase; and
recovering the carbon filamentary structures from the gaseous phase.

According to another aspect of the present invention, there is provided a method of purifying carbon filamentary structures contaminated with magnetic metal particles, the method comprising:
providing a gaseous phase comprising the carbon filamentary structures contaminated with magnetic metal particles;
optionally submitting the gaseous phase to a disturbance in order to reduce the amount of carbon filamentary structures having magnetic metal particles attached or linked thereto, present in the gaseous phase;
submitting the gaseous phase to an inhomogeneous magnetic field for at least partially trapping the magnetic metal particles, thereby reducing the proportion of the magnetic metal particles present in the gaseous phase; and
recovering the carbon filamentary structures from the gaseous phase.

According to another aspect of the present invention, there is provided a method of purifying carbon filamentary structures contaminated with magnetic metal particles. The method comprises the steps of:

a) providing a gaseous phase comprising the carbon filamentary structures having the magnetic metal particles attached or linked thereto;

b) submitting the gaseous phase to a disturbance so as to cause the carbon filamentary structures to become substantially physically separated from the magnetic metal particles;

c) submitting the gaseous phase obtained in step (b) to an inhomogeneous magnetic field so as to substantially trap the magnetic metal particles, thereby reducing the amount of the magnetic metal particles in the gaseous phase; and

d) recovering the carbon filamentary structures from the gaseous phase.

It was found that the latter four methods are quite efficient for carrying out the purification of carbon filamentary structures. In fact, it was observed that such methods permit to rapidly purify and isolate the desired carbon filamentary structures.

According to another aspect of the present invention, there is provided a continuous method for purifying carbon filamentary structures contaminated with magnetic metal particles, comprising the steps of:

a) treating a gaseous phase comprising the carbon filamentary structures contaminated with magnetic metal particles, with or without a disturbance in order to reduce the amount of carbon filamentary structures having magnetic metal particles attached or linked thereto, present in the gaseous phase;

b) submitting the gaseous phase to an inhomogeneous magnetic field for at least partially trapping the magnetic metal particles, thereby reducing the proportion of the magnetic metal particles present in the gaseous phase;

c) providing a device comprising:
an inlet;
a valve comprising an inlet and at least two outlets, the outlets being adapted to be selectively put in fluid flow communication with the inlet of the valve, the inlet of the valve being in fluid flow communication with the inlet of the device;
at least two depositing units each of the units comprising a set of at least two electrodes, a first electrode and a second electrode defining a space therebetween, the space being in fluid flow communication with one of the outlets of the valve and being dimensioned to receive the gaseous phase;

d) passing the gaseous phase through the inlet of the device, the valve and a selected depositing unit; and applying a potential difference between the electrodes of the selected depositing unit to thereby deposit carbon filamentary structures on at least one electrode; and

e) selecting another depositing unit and repeating step (d).

According to another aspect of the present invention, there is provided a continuous method of purifying carbon filamentary structures contaminated with magnetic metal particles, comprising the steps of:

a) providing a gaseous phase comprising the carbon filamentary structures contaminated with magnetic metal particles;

b) optionally submitting the gaseous phase to a disturbance in order to reduce the amount of carbon filamentary structures having magnetic metal particles attached or linked thereto, present in the gaseous phase;

c) submitting the gaseous phase to an inhomogeneous magnetic field for at least partially trapping the magnetic metal particles, thereby reducing the proportion of the magnetic metal particles present in the gaseous phase;

d) providing a device comprising:
an inlet;
a valve comprising an inlet and at least two outlets, the outlets being adapted to be selectively put in fluid flow communication with the inlet of the valve, the inlet of the valve being in fluid flow communication with the inlet of the device;
at least two depositing units each of the units comprising a set of at least two electrodes, a first electrode and a second electrode defining a space therebetween, the space being in fluid flow communication with one of the outlets of the valve and being dimensioned to receive the gaseous phase;

e) passing the gaseous phase through the inlet of the device, the valve and a selected depositing unit; and applying a potential difference between the electrodes of the selected depositing unit to thereby deposit carbon filamentary structures on at least one electrode; and

f) selecting another depositing unit and repeating step (e).

According to another aspect of the present invention, there is provided a continuous method of purifying carbon filamentary structures contaminated with magnetic metal particles. The continuous method comprises the steps of:

a) providing a gaseous phase comprising the carbon filamentary structures having the magnetic metal particles attached or linked thereto;

b) submitting the gaseous phase to a disturbance so as to cause the carbon filamentary structures to become substantially physically separated from the magnetic metal particles;

c) submitting the gaseous phase obtained in step (b) to an inhomogeneous magnetic field so as to substantially trap the magnetic metal particles, thereby reducing the amount of the magnetic metal particles in the gaseous phase;

d) providing a depositing device comprising:
an inlet;
a valve comprising an inlet and at least two outlets, the outlets being adapted to be selectively put in fluid flow communication with the inlet of the valve, the inlet of the valve being in fluid flow communication with the inlet of the device; and
depositing units each comprising a set at least two electrodes, a first electrode and a second electrode defining a space therebetween, the space being in fluid flow communications with one outlet of the valve and being dimensioned to receive the gaseous phase comprising the carbon filamentary structures;

e) passing the gaseous phase through the inlet of the device, the valve and a selected one of the depositing units; and applying a potential difference between the electrodes of the selected depositing unit to thereby deposit carbon filamentary structures on at least one electrode; and

f) selecting another one of the depositing units and repeating step (e).

According to another aspect of the invention, there is provided a continuous method of purifying carbon filamentary structures contaminated with magnetic metal particles, comprising the steps of:

a) providing an apparatus comprising:
a housing having a chamber dimensioned to receive a gaseous phase comprising the carbon filamentary structures having the magnetic metal particles attached or linked thereto, a first inlet and a first outlet, the first inlet and the first outlet being in fluid flow communication with the chamber;
a disturbance generator disposed inside or adjacent to the chamber, the disturbance generator being adapted to submit the gaseous phase to a disturbance;
an inhomogeneous magnetic field generator disposed inside or adjacent to the chamber and downstream of the disturbance generator, the magnetic field generator being adapted to substantially trap the magnetic metal particles;
a valve adjacent and downstream of the inhomogeneous magnetic field generator, the valve comprising an inlet and at least two outlets, the outlets being adapted to be selectively put in fluid flow communication with the inlet of the valve, the inlet of the valve being in fluid flow communication with the chamber; and
depositing units each comprising a set at least two electrodes, a first electrode and a second electrode defining a space therebetween, the space being in fluid flow communications with one outlet of the valve and being dimensioned to receive the gaseous phase comprising the carbon filamentary structures;

b) providing the gaseous phase and passing it through the first inlet and introducing it in the chamber;

c) submitting the gaseous phase to the disturbance generated by the disturbance generator so as to cause the carbon filamentary structures to become substantially physically separated from the magnetic metal particles;

d) submitting the gaseous phase obtained in step (c) to the inhomogeneous magnetic field generated by the inhomogeneous magnetic field generated so as to substantially trap the magnetic metal particles, thereby reducing the amount of the magnetic metal particles in the gaseous phase; and

e) passing the gaseous phase obtained in step (d) through the inlet of the valve and a selected one of the depositing units; and applying a potential difference between the electrodes of the selected depositing unit to thereby deposit carbon filamentary structures on at least one electrode; and

f) selecting another of the depositing units and repeating step (e).

It was found that by using the latter four methods, it is possible to purify and recover carbon filamentary structures in a continuous manner. In fact, such methods can be particularly useful when a gas-phase synthesis of carbon filamentary structures is carried out. In such a case, the whole process of the production including, synthesis, purification, deposition and recovery can be carried out in a continuous manner and in situ. It thus constitutes a considerable advantage over previously known process in which the synthesis must be stopped for collecting the carbon filamentary structures and then, the carbon filamentary structures must be treated with various chemicals in order to purify them. The latter four methods thus permit to carry out the production of carbon filamentary structures rapidly, efficiently and by avoiding tedious tasks and use of various chemicals.

According to another aspect of the present invention, there is provided an apparatus for treating carbon filamentary structures contaminated with metal particles, in order to at least partially separate the carbon filamentary structures from the metal particles. The apparatus comprises:

a housing having a chamber dimensioned to receive a gaseous phase comprising the carbon filamentary structures contaminated with metal particles, an inlet and an outlet, the inlet and the outlet being in fluid flow communication with the chamber; and

a disturbance generator disposed inside or adjacent to the chamber, the disturbance generator being adapted to submit the gaseous phase to a disturbance in order to at least partially separate the carbon filamentary structures from the metal particles.

According to another aspect of the invention, there is provided an apparatus for treating carbon filamentary structures having metal particles attached or linked thereto, to separate the carbon filamentary structures from the metal particles. The apparatus comprises:

a housing having a chamber dimensioned to receive a gaseous phase comprising the carbon filamentary structures and the metal particles, an inlet and an outlet, the inlet and the outlet being in fluid flow communication with the chamber; and

a disturbance generator disposed inside or adjacent to the chamber, the disturbance generator being adapted to submit the gaseous phase to a disturbance so as to cause the carbon filamentary structures to become substantially physically separated from the metal particles.

It was found that the latter two apparatuses are efficient and very useful for physically separating, at least a portion, of the carbon filamentary structures from the metal particles. In fact, such apparatuses permit to physically separate the carbon filamentary structure from the metal particle, for at least a portion of the totality of carbon filamentary structures contaminated with the metal particles. By treating a gaseous phase comprising carbon filamentary structures with such apparatuses, at least a portion of the carbon filamentary structures that are attached or linked to a metal will be separated from the metal, thereby reducing the amount of carbon filamentary structures having metal particles attached or linked thereto. The metal particles can be magnetic or non-magnetic metal particles.

According to another aspect of the present invention, there is provided an apparatus for purifying carbon filamentary structures contaminated with magnetic metal particles. The apparatus comprises:

a housing having a chamber dimensioned to receive a gaseous phase comprising the carbon filamentary structures contaminated with magnetic metal particles, an inlet and an outlet, the inlet and the outlet being in fluid flow communication with the chamber; and

an inhomogeneous magnetic field generator disposed inside or adjacent to the chamber, the magnetic field generator being adapted to at least partially trap the magnetic metal particles in order to reduce the proportion of magnetic metal particles present in the gaseous phase.

According to another aspect of the invention, there is provided an apparatus for purifying carbon filamentary structures contaminated with magnetic metal particles, comprising:

a housing having a chamber dimensioned to receive a gaseous phase comprising the carbon filamentary structures and the magnetic metal particles, the carbon filamentary structures being substantially physically separated from the magnetic metal particles, an inlet and an outlet, the inlet and the outlet being in fluid flow communication with the chamber; and

an inhomogeneous magnetic field generator disposed inside or adjacent to the chamber, the magnetic field generator being adapted to substantially trap the magnetic metal particles, thereby reducing the amount of the magnetic metal particles in the gaseous phase.

It was found that by using the latter two apparatuses, purification of carbon filamentary structures can be carried out rapidly and efficiently. It was also found that such apparatuses permitting to carry out the purification in gaseous phase have considerable advantages since the carbon filamentary structures can be purified directly after their synthesis, without requiring any step or task between the synthesis and the purification. In fact, the carbon filamentary structures that are preferably obtained from a gas phase synthesis such as a plasma torch are already in a gaseous phase and thus, the purification can be carried out directly without the necessity of recovering them and then treating them so as to remove the impurities. Such apparatuses thus permit to carry out the synthesis and purification of carbon filamentary structures in a single sequence or in a “one-pot” manner. Such apparatuses can also be used to purify carbon filamentary structures that are produced by other methods than a gas phase synthesis. In fact, carbon filamentary structures in solid or powder form can be mixed with a gas in order to obtain a gaseous phase and then, such a gaseous phase can be treated with one of the apparatuses. In fact, such apparatuses are in situ purification apparatuses, since the carbon filamentary structures are purified directly in the gaseous phase in which they have been generated.

According to another aspect of the present invention there is provided an apparatus for purifying carbon filamentary structures contaminated with magnetic metal particles. The apparatus comprises:

a housing having a chamber dimensioned to receive a gaseous phase comprising the carbon filamentary structures contaminated with magnetic metal particles, an inlet and an outlet, the inlet and the outlet being in fluid flow communication with the chamber;

a disturbance generator disposed inside or adjacent to the chamber, the disturbance generator being adapted to submit the gaseous phase to a disturbance in order to at least partially separate the carbon filamentary structures from the magnetic metal particles; and

an inhomogeneous magnetic field generator disposed inside or adjacent to the chamber, and preferably downstream of the disturbance generator, the magnetic field generator being adapted to at least partially trap the magnetic metal particles present in the gaseous phase in order to reduce the proportion of magnetic metal particles present in the gaseous phase.

According to another aspect of the invention, there is provided an apparatus for purifying carbon filamentary structures contaminated with magnetic metal particles, comprising:

a housing having a chamber dimensioned to receive a gaseous phase comprising the carbon filamentary structures having the magnetic metal particles attached or linked thereto, an inlet and an outlet, the inlet and the outlet being in fluid flow communication with the chamber;

a disturbance generator disposed inside or adjacent to the chamber, the disturbance generator being adapted to submit the gaseous phase to a disturbance so as to cause the carbon filamentary structures to become substantially physically separated from the magnetic metal particles; and

an inhomogeneous magnetic field generator disposed inside or adjacent to the chamber, the magnetic field generator being adapted to substantially trap the magnetic metal particles, thereby reducing the amount of the magnetic metal particles in the gaseous phase.

It was found that the latter two apparatuses permit carry out efficiently and rapidly purification of carbon filamentary structures. In fact, it was observed that when the carbon filamentary structures are first submitted to a disturbance and then to the inhomogeneous magnetic field, superior results were obtained i.e. a higher purity was observed. In fact, it is believed, without being bounded to such an explanation, that such better results are obtained since the treatment with the disturbance permits to obtain a higher content or proportion, in the gaseous phase, of metal particles that are not attached or linked to carbon filamentary structures. Thus, the disturbance generator permits to increase the efficiency of the purification carried out with the inhomogeneous magnetic field as compared to an apparatus in which only an inhomogeneous magnetic field generator is used. In fact, such apparatuses are in situ purification apparatuses, since the carbon filamentary structures are purified directly in the gaseous phase in which they have been generated.

According to another aspect of the present invention, there is provided an apparatus for purifying carbon filamentary structures contaminated with magnetic metal particles. The apparatus comprises:

a housing having a chamber dimensioned to receive a gaseous phase comprising the carbon filamentary structures having the magnetic metal particles attached or linked thereto, an inlet and an outlet, the inlet and the outlet being in fluid flow communication with the chamber;

a disturbance generator disposed inside or adjacent to the chamber, the disturbance generator being adapted to submit the gaseous phase to a disturbance so as to cause the carbon filamentary structures to become substantially physically separated from the magnetic metal particles;

an inhomogeneous magnetic field generator disposed inside or adjacent to the chamber, and preferably downstream of the disturbance generator, the magnetic field generator being adapted to substantially trap the magnetic metal particles, thereby reducing the amount of the magnetic metal particles in the gaseous phase; and

at least two electrodes disposed downstream of the inhomogeneous magnetic field generator in the chamber, the electrodes defining therebetween a space dimensioned to receive the gaseous phase comprising carbon filamentary structures, the electrodes being adapted to generate an electric field for depositing the carbon filamentary structures on at least one of the electrodes.

According to another aspect of the invention, there is provided an apparatus for purifying carbon filamentary structures contaminated with magnetic metal particles, comprising:

a housing having a chamber dimensioned to receive a gaseous phase comprising the carbon filamentary structures having the magnetic metal particles attached or linked thereto, an inlet and an outlet, the inlet and the outlet being in fluid flow communication with the chamber;

a disturbance generator disposed inside or adjacent to the chamber, the disturbance generator being adapted to submit the gaseous phase to a disturbance so as to cause the carbon filamentary structures to become substantially physically separated from the magnetic metal particles;

an inhomogeneous magnetic field generator disposed inside or adjacent to the chamber, the magnetic field generator being adapted to substantially trap the magnetic metal particles, thereby reducing the amount of the magnetic metal particles in the gaseous phase; and

a first electrode and a second electrode disposed downstream of the inhomogeneous magnetic field generator in the chamber, and connected to the housing, the first and second electrodes defining therebetween a space dimensioned to receive the gaseous phase comprising carbon filamentary structures, the electrodes being adapted to generate an electric field for depositing the carbon filamentary structures on at least one of the electrodes.

It was found that the latter two apparatuses are efficient for carrying out the purification of carbon filamentary structures. In fact, it was observed that such apparatuses permit to rapidly purify and isolate the desired carbon filamentary structures.

An apparatus for purifying carbon filamentary structures contaminated with magnetic metal particles, comprising:

a housing having a chamber dimensioned to receive a gaseous phase comprising the carbon filamentary structures having the magnetic metal particles attached or linked thereto, an inlet and an outlet, the inlet and the outlet being in fluid flow communication with the chamber;

a disturbance generator disposed inside or adjacent to the chamber, the disturbance generator being adapted to submit the gaseous phase to a disturbance so as to cause the carbon filamentary structures to become substantially physically separated from the magnetic metal particles;

an inhomogeneous magnetic field generator disposed inside or adjacent to the chamber, and preferably downstream of the disturbance generator, the magnetic field generator being adapted to substantially trap the magnetic metal particles, thereby reducing the amount of the magnetic metal particles in the gaseous phase;
at least one inlet dimensioned to receive a gaseous phase comprising the carbon filamentary structures;
at least one selecting device comprising an inlet and at least two outlets, the outlets being adapted to be selectively put in fluid flow communication with the inlet of the selecting device, the inlet of the selecting device being in fluid flow communication with the inlet of the apparatus; and
at least two depositing units each of the units comprising a set of at least two electrodes, a first electrode and a second electrode defining therebetween a space dimensioned to receive the gaseous phase, the space being in fluid flow communication with one outlet of the selecting device, the electrodes being adapted to generate an electric field for depositing the carbon filamentary structures on at least one of them.

It was found that the latter apparatus is efficient for carrying out the purification of carbon filamentary structures. In fact, it was observed that such apparatuses permit to rapidly purify and isolate the desired carbon filamentary structures. Moreover, it was observed that such an apparatus permits to purify carbon filamentary structures in a continuous manner.

The expression “carbon filamentary structures contaminated with magnetic metal particles” as used herein refers to a mixture that can comprise carbon filamentary structures having magnetic metal particles attached thereto and/or linked thereto, magnetic metal particles that can be coated with or embedded in amorphous carbon and/or graphitic carbon, optionally carbon filamentary structures that are neither attached nor linked to metal particles, and optionally magnetic metal particles that are neither attached nor linked to carbon filamentary structures. The metal particles are preferably catalyst metal particles.

The expression “attached thereto” as used herein when referring to carbon filamentary structures and metal particles is intended to mean that there is a bonding between carbon filamentary structures and metal particles. This bonding preferably occurs at the surface or the extremities of the carbon filamentary structures. The bonding can be a chemical bonding such as a covalent, ionic or a metallic bonding that is strong. The metal particles are preferably magnetic metal particles.

The expression “linked thereto” as used herein when referring to carbon filamentary structures and metal particles is intended to mean that there is a bonding between carbon filamentary structure and metal particles. This bonding is a polarisation bonding like van der Waals interaction or hydrogen bonds between the carbon filamentary structure and the metal particles. This bonding preferably occurs at the surface or the extremities of the carbon filamentary structures. The carbon filamentary structure can also be indirectly bonded to the metal particles such as when metal particles are embedded in amorphous carbon, which is bonded to the carbon filamentary structures at their surface or extremities. The metal particles are preferably magnetic metal particles.

In the methods and apparatuses of the present invention, the carbon filamentary structures can be selected from the group consisting of single-wall carbon nanotubes, multi-wall carbon nanotubes, carbon fibres, and mixtures thereof. Preferably, the carbon filamentary structures are selected from the group consisting of single-wall carbon nanotubes, multi-wall carbon nanotubes, and a mixture thereof. More preferably, the carbon filamentary structures are single-wall carbon nanotubes.

In the methods and apparatuses of the present invention, the gaseous phase preferably comprises a carrier gas. The carrier gas can be selected from the group consisting of He, Ar, H₂, H₂O, H₂S, CO₂, CO, N₂, Kr, Xe, Ne, and mixtures thereof. Preferably, the carrier gas is a mixture of argon and helium. The gaseous phase can contain a density of about 1×10² to about 1×10¹² carbon filamentary structures per cm³ and preferably of about 1×10⁷ to about 1×10¹⁰ carbon filamentary structures per cm³.

In the methods and apparatuses of the present invention, the metal of the magnetic metal particles can be selected from the group consisting of Co, Fe, Mo Ni, Pd, Rh, Ru, Y, La, Ce, and mixtures thereof. Preferably, the metal is selected from the group consisting of Co, Fe, Ni, and mixtures thereof. Alternatively, the magnetic metal particles can comprise at least one metal selected from the group consisting of Co, Fe, and Ni, together with a non-ferromagnetic metal. The magnetic metal particles may have a carbon coating.

In the methods and apparatuses of the present invention, wherein a disturbance is caused, the disturbance can be caused by an alternative current (AC) or pulsed electric field, an AC or pulsed magnetic field, ultrasounds, a turbulent gas stream, or combinations thereof. The electric field can be a macroscopic field having a value of about 1×10³ V/m to about 1×10⁷ V/m and preferably of about 1×10⁵ V/m to about 1×10⁶ V/m. When the disturbance is caused by an AC electric field, the AC electric field can have a frequency ranging from 1 KHz to 5 GHz and preferably from 20 KHz to 20 MHz. When the disturbance is caused by a pulsed electric field, the pulsed electric field can have a repetition rate ranging from 20 KHz to 20 MHz. The disturbance can also be caused by a mixture of an AC and a DC voltage. When the disturbance is caused by an AC magnetic field, the latter can have a frequency ranging from 20 KHz to 20 MHz. When the disturbance is caused by ultrasounds, the ultrasounds can have a power level ranging from 0.2 to 500 W/cm², preferably from 1 to 150 W/cm², the ultrasounds can also have a frequency ranging from 20 KHz to 500 MHz. The disturbance can be generated by a turbulent gas stream having a speed ranging from Mach 1 to 6. Such a gas can be selected from the group consisting of He, Ar, H₂, H₂O, CO₂, CO, N₂, Kr, Xe, Ne, and mixtures thereof. Preferably, the gas is selected from the group consisting of Ar, He, H₂, and mixtures thereof.

In the methods and apparatuses of the present invention wherein an inhomogeneous magnetic field is generated, the latter can have an amplitude ranging from 0.001 to 15 Tesla and preferably from 0.1 to 5 Tesla. The inhomogeneous magnetic field can have a gradient having amplitude ranging from 0.01 to 10 Tesla/m and preferably from 0.1 to 100 Tesla/m. Such an inhomogeneous magnetic field can be generated by a permanent magnet, an electromagnet, a solenoid, a coil or a combination of coils. The gaseous phase can also be submitted to a centrifugal force while being submitted to an inhomogeneous magnetic field. The treatment with the inhomogeneous magnetic field can permit to reduce the proportion of the metal particles present in the gaseous phase. Such a treatment can also permit to reduce the proportion or content, in weight %, of the metal particles in the gaseous phase. The treatment with the inhomogeneous magnetic field can also permit to reduce the ratio magnetic metal particles:carbon filamentary structures, in the gaseous phase.

In the methods and apparatuses of the present invention the gaseous phase (and more particularly the carbon filamentary structures having magnetic metal particles attached thereto and/or linked thereto) can be substantially simultaneously submitted to the disturbance and the inhomogeneous magnetic field. In fact, the disturbance generator and the inhomogeneous magnetic field generator can be disposed in the apparatus in such a manner that at a least a portion of the carbon filamentary structures having magnetic metal particles attached thereto and/or linked thereto being treated, can be simultaneously submitted to the effect of both the disturbance and the magnetic field. The treating zone or effective zone of treatment of the disturbance and the magnetic field can thus overlap or be substantially the same. In a similar manner, the carbon filamentary structures can be substantially simultaneously submitted to the action of the inhomogeneous magnetic field and the electric field of the electrodes used for depositing the desired structures. They can also be substantially simultaneously submitted to the action of the disturbance, the magnetic field, and the electric field or submitted simultaneously to the disturbance and the electric field. The disturbance and magnetic field generators as well as the electrodes can thus be disposed accordingly so as to provide the desired overlapping zones of treatment.

In the methods of the present invention in which a recovering step is carried out, this step is carried out by depositing the purified carbon filamentary structures on at least one electrode and then collecting the purified and deposited carbon filamentary structures. The recovering step can be carried out by depositing and then collecting the purified carbon filamentary structures, the depositing step being carried out passing a gaseous phase comprising the carbon filamentary structures through a space defined between at least two electrodes generating an electrical field, for depositing the carbon filamentary structures on at least one of the electrodes. The carbon filamentary structures are preferably deposited by substantially preventing the deposited carbon filamentary structures from bridging the electrodes during the deposition. The carbon filamentary structures can be deposited by substantially removing, during the deposition of the carbon filamentary structures, any structures that are bridging the at least two electrodes from such a position by removing at least a portion of these structures from contacting one of the electrodes. The electrodes are preferably in rotation relation to one another in order to prevent being bridged by the deposited carbon filamentary structures.

In the method of the invention for purifying carbon filamentary structures contaminated with magnetic metal particles depositing of the carbon filamentary structures can be carried out as follows:

i) providing a set of electrodes comprising at least two electrodes, a first electrode and a second electrode defining a space therebetween;

ii) applying a potential difference between the electrodes in order to generate an electric field; and

iii) passing the gaseous phase through the space, thereby depositing the carbon filamentary structures on at least one of the electrodes.

Preferably, the deposit of carbon filamentary structures comprises a plurality of filaments of the carbon filamentary structures forming together a web-like structure. The deposit can have a foamy aspect. The first electrode can comprise a housing defining a chamber dimensioned to receive the second electrode. The second electrode can be longitudinally aligned with the first electrode. Preferably, the first and second electrodes are parallel. More preferably, the second electrode is disposed in a substantially coaxial alignment into the chamber. The second electrode can be disposed into the chamber in a substantially perpendicular manner to the housing. The second electrode can be rotated at a predetermined speed, thereby preventing the deposit from bridging the electrodes.

Preferably, the second electrode is rotated at a speed of about 10⁻² to about 500 rpm and more preferably of about 0.1 to about 200 rpm and even more preferably of about 1 to about 30 rpm. The deposit is preferably rolled-up around the second electrode. The current density can have an intensity of about 0 to about 500 μA/cm², preferably of about 0.1 to about 80 μA/cm², which is collected to the electrodes. The electric field can be a macroscopic field having a value of about 1×10³ V/m to about 1×10⁷ V/m and preferably of about 1×10⁵ V/m to about 1×10⁶ V/m. The potential difference can be of about 0.1 to about 50000 V. Another gas can be injected through the space so as to slow down the carbon filamentary structures passing through the space. The other gas is preferably injected in a counter-current manner to the gaseous phase. The other gas is preferably helium. The potential difference applied between the electrodes is preferably a Direct Current voltage.

In the apparatuses of the invention, the disturbance generator can comprise an alternative current (AC) or pulsed electric field generator, an AC or pulsed magnetic field generator, an ultrasounds generator, a turbulent gas stream, or combinations thereof. The disturbance generator can comprise at least two electrodes defining therebetween a space dimensioned to receive the gaseous phase comprising carbon filamentary structures and magnetic metal particles, the electrodes being adapted to generate an electric field for causing a substantial separation of the carbon filamentary structures from magnetic metal particles. The disturbance generator can comprise a time variable magnetic field. The variable magnetic field can be generated by a solenoid, an electromagnet, a coil, or a combination of coils. The disturbance generator can comprise an ultrasounds generator. The disturbance generator can comprise a turbulent gas stream generator, preferably a supersonic gas generator. The generator can comprise at least two electrodes adapted to generate a time variable electric field. The inhomogeneous magnetic field generator can be a permanent magnet, an electromagnet, a solenoid, a coil, or a combination of coils. The disturbance generator can be disposed outside the chamber and connected to or in close proximity with the housing.

The first and second electrodes define therebetween a space dimensioned to receive the gaseous phase comprising carbon filamentary structures and magnetic metal particles. The electrodes are adapted to generate an electric field for causing substantial separation of the carbon filamentary structures from magnetic metal particles. A portion of the housing can constitute the first electrode. Alternatively, the disturbance generator can be an ultrasounds generator or a turbulent gas stream generator. Preferably, the second electrode is longitudinally aligned with the housing. The second electrode can be parallel to the first electrode. The second electrode can be disposed in a substantially coaxial alignment with the elongated member. The second electrode is preferably disposed into the chamber in a substantially perpendicular alignment to the housing. The second electrode can be rotatably mounted on the housing. The apparatus can also comprise a motor for rotating the second electrode. The first and second electrodes can be cylindrical electrodes.

In the apparatuses of the invention having an inhomogeneous magnetic field generator, the latter can be a permanent magnet, an electromagnet, a solenoid, a coil, or a combination of coils. The housing can have a curved portion and wherein the inhomogeneous magnetic field generator disposed inside or adjacent to the curved portion so as to submit the gaseous phase to a centrifugal force while being submitted to an inhomogeneous magnetic field. The inhomogeneous magnetic field generator is preferably disposed outside the chamber and connected to or in close proximity with the housing.

### BRIEF DESCRIPTION OF THE DRAWINGS

Further features and advantages of the invention will become more readily apparent from the following description of preferred embodiments as illustrated by way of examples in the appended drawings wherein:

FIG. 1 is a schematic sectional elevation view of a system comprising an apparatus for producing carbon filamentary structures and an apparatus for treating carbon filamentary structures having metal particles attached or linked thereto, or an apparatus for purifying carbon filamentary structures contaminated with magnetic metal particles, according to preferred embodiments of the invention, wherein the carbon filamentary structures are single-wall carbon nanotubes;

FIG. 2 is a schematic sectional elevation view of an apparatus for treating carbon filamentary structures having metal particles attached or linked thereto, according to another preferred embodiment of the invention;

FIG. 3 is a schematic sectional elevation view of an apparatus for treating carbon filamentary structures having metal particles attached or linked thereto, according to another preferred embodiment of the invention;

FIG. 4 is a schematic sectional elevation view of an apparatus for treating carbon filamentary structures having metal particles attached or linked thereto, according to another preferred embodiment of the invention;

FIG. 5 is a schematic sectional elevation view of an apparatus for treating carbon filamentary structures having metal particles attached or linked thereto, according to another preferred embodiment of the invention;

FIG. 6 is a schematic sectional elevation view of an apparatus for purifying carbon filamentary structures according to another preferred embodiment of the invention;

FIG. 7 is a cross-sectional view of the apparatus shown in FIG. 6;

FIG. 8 is a schematic sectional elevation view of an apparatus for purifying carbon filamentary structures according to another preferred embodiment of the invention;

FIG. 9 a schematic sectional elevation view of an apparatus for purifying carbon filamentary structures according to another preferred embodiment of the invention;

FIG. 10 is a schematic sectional elevation view of an apparatus for purifying carbon filamentary structures according to another preferred embodiment of the invention;

FIG. 11 is a schematic sectional elevation view of an apparatus for purifying carbon filamentary structures according to another preferred embodiment of the invention;

FIG. 12 is a schematic sectional elevation view of an apparatus for depositing carbon filamentary structures according to another preferred embodiment of the invention;

FIG. 13 is a graph of a Thermogravimetric Analysis (TGA) with their derivatives of carbon filamentary structures (plain line) treated with an apparatus for purifying carbon filamentary structures according to a preferred embodiment the present invention, wherein the dash line represents the TGA analysis of magnetic metal particles originally contained in the carbon filamentary structures and which have been trapped during the purification process, wherein the carbon filamentary structures are single-wall carbon nanotubes;

FIG. 14 is a Transmission Electron Microscope (TEM) image of carbon filamentary structures containing catalyst particles and amorphous carbon that have been recovered downstream of an apparatus for purifying carbon filamentary structures according to another preferred embodiment of the present invention, wherein the carbon filamentary structures are single-wall carbon nanotubes;

FIG. 15 is a Transmission Electron Microscope (TEM) image of a deposit comprising essentially catalyst particles coated with carbon that have been trapped in an apparatus for purifying carbon filamentary structures according to another preferred embodiment of the present invention, wherein the carbon filamentary structures are single-walled carbon nanotubes and the catalyst particules are magnetic metal particles;

FIG. 16 is a Transmission Electron Microscope (TEM) image of a closer view of the deposit of magnetic metal particles of FIG. 15; and

FIG. 17 is a Transmission Electron Microscope (TEM) image of a closer view of the region indicated with an arrow in the FIG. 16 showing the graphitic shells covering the catalyst nanoparticles trapped in the previously mentioned purification apparatus, wherein the magnetic metal catalyst is iron.

### DETAILED DESCRIPTION OF PREFERRED EMBODIMENTS OF THE INVENTION

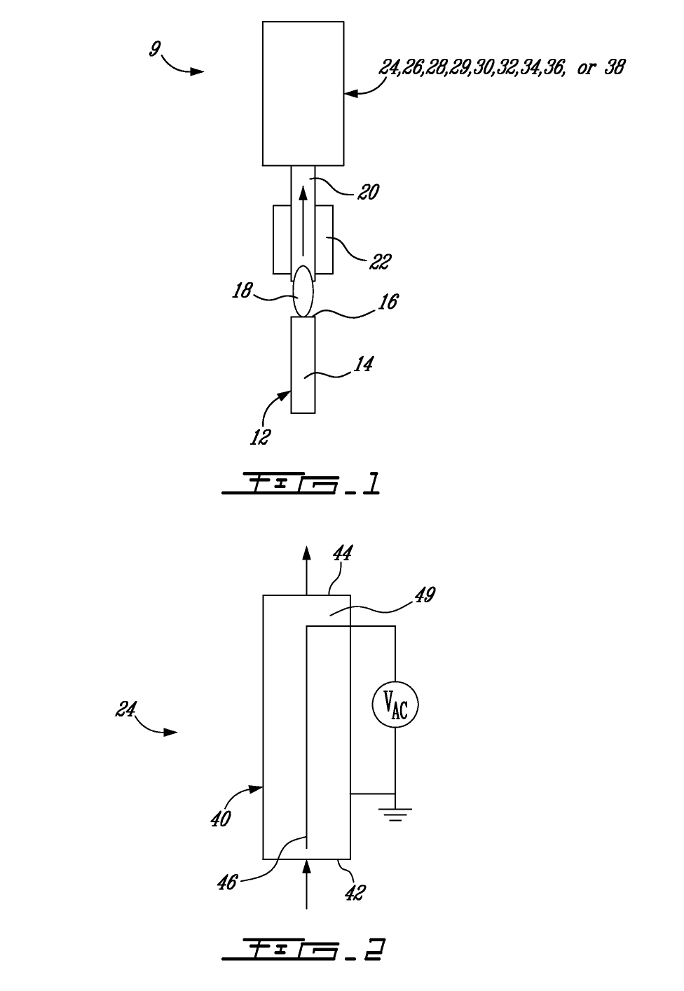

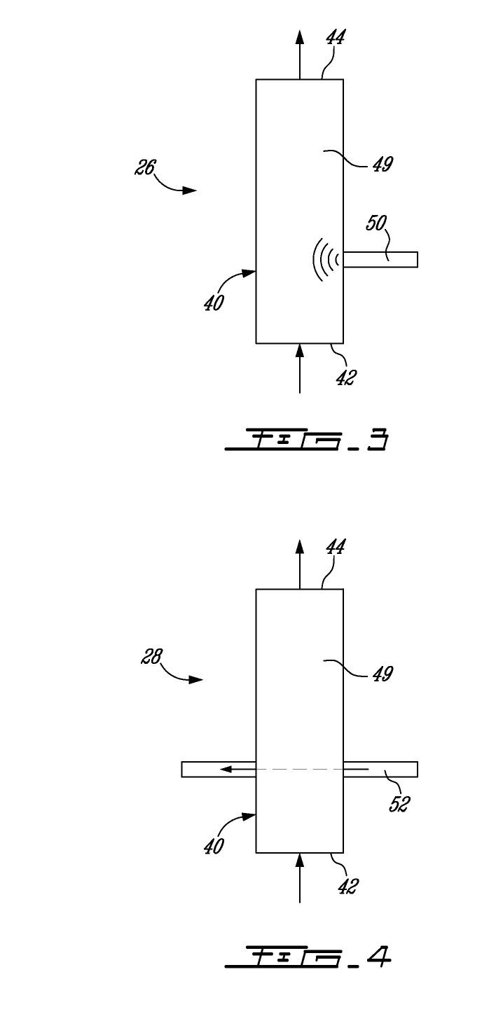

Referring first to FIG. 1, there is shown a system 9 for producing carbon filamentary structures and treating such structures having metal particles attached or linked thereto, or an apparatus for purifying carbon nanotubes containing catalyst metal particles. The system 9 is preferably used for the production of carbon nanotubes and more preferably single-wall carbon nanotubes. The system 9 comprises a plasma torch 12 having a plasma tube 14 with a plasma-discharging end 16, the plasma torch generating a plasma 18 comprising a portion of ionized atoms of an inert gas, a carbon-containing substance and the metal catalyst. The system also comprises a quartz tube 20 in fluid flow communication with the plasma-discharging end 16, disposed in an oven 22. The methods and apparatuses of the present invention can be used downstream of various means for preparing carbon filamentary structures such as (RF or induction plasma torches, transferred arcs plasma torches, DC plasma torches, microwaves plasma torches etc.), HiPco, laser vaporization, chemical vapor deposition, laser ablation and electric arc. When used downstream of a plasma torch the latter can be a plasma torch as defined in US 2003/0211030, U.S. Pat. No. 5,395,496 or U.S. Pat. No. 5,147,998 (O. Smiljanic et al., Chemical Physics Letters 356 (2002), 189; D. Harbec et al., J. Phys. D: Appl. Phys. 37 (2004), 2121; J. Hahn et al., Carbon 42 (2004), 877; G. Cota-Sanchez et al., Carbon 43 (2005), 3153), which are hereby incorporated by reference in their entirety. An apparatus for at least partially separating carbon filamentary structures from metal particles (24, 26, 28, or 29) (see FIGS. 2 to 5) or an apparatus for purifying carbon filamentary structures (30, 32, 34, 36, or 38) (see FIGS. 6 to 11) is disposed downstream of the tube 20 and is in fluid flow communication with the latter. The particles contained in the plasma 18 enter the oven 22. Before the oven 22, the atoms or molecules of carbon and atoms of metal catalyst are condensed to result in the formation of single-wall carbon nanotubes, multi-wall carbon nanotubes or a mixture thereof. During the synthesis metal particles such as iron catalyst nanoparticles and amorphous carbon are also formed in the gaseous phase. This gaseous phase is then introduced in the corresponding apparatus 24, 26, 28, 29, 30, 32, 34, 36, or 38 (see FIGS. 2 to 11). The metal nanoparticles catalyze the formation of nanotubes, which grow at the surface of such particles. However, some catalyst nanoparticles are not exposed to the appropriate synthesis conditions during the cooling of the plasma. These nanoparticles thus neither participate in nor contribute to the formation of the carbon filamentary structures such as nanotubes. They can thus be covered with a carbon coating that can be a graphitic shell. Such a coating can render more difficult the task of removing them form the desired product during conventional purification procedures. However, such a task is considerably facilitated by using the methods and apparatuses of the present invention and more particularly the methods and apparatuses that permit to treat the structures with a disturbance.

In FIG. 2, the apparatus 24 for treating carbon filamentary structures and preferably carbon nanotubes having metal particles attached or linked thereto, comprises a housing (or elongated member) 40 defining a chamber 49, and having an inlet 42 and an outlet 44. The housing 40 acts as a first electrode and a second electrode 46 is inserted through the chamber 49 of the housing 40. The electrodes 40 and 46 are spaced-apart and a space 48 is defined therebetween. Electrodes 40 and 46 are in substantially parallel relationship and preferably in parallel relationship. More preferably, they are substantially coaxially aligned. A time variable voltage difference, preferably an alternative current (AC) voltage difference is applied between electrodes 40 and 46. The electrode 46 can also be a rotating electrode as shown in FIG. 12.

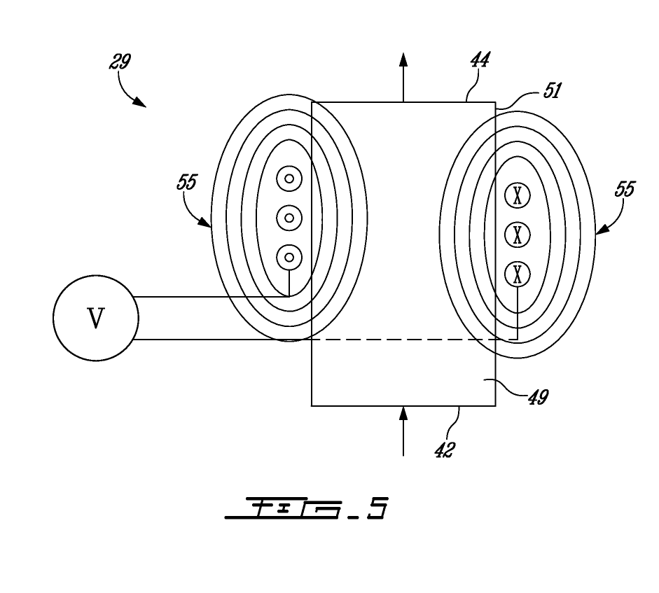

In FIG. 3, the apparatus 26 for treating carbon filamentary structures and preferably carbon nanotubes having metal particles attached or linked thereto, comprises a housing (or elongated member) 40 defining chamber 49, and having an inlet 42 and an outlet 44. The apparatus 26 also comprises a device 50 for generating ultrasounds (or an ultrasounds generator) in the chamber of the housing 40. The ultrasounds are represented by the sound waves. The device 50 can alternatively be disposed adjacently to the inlet 42 or the outlet 44, inside or outside the chamber 49.

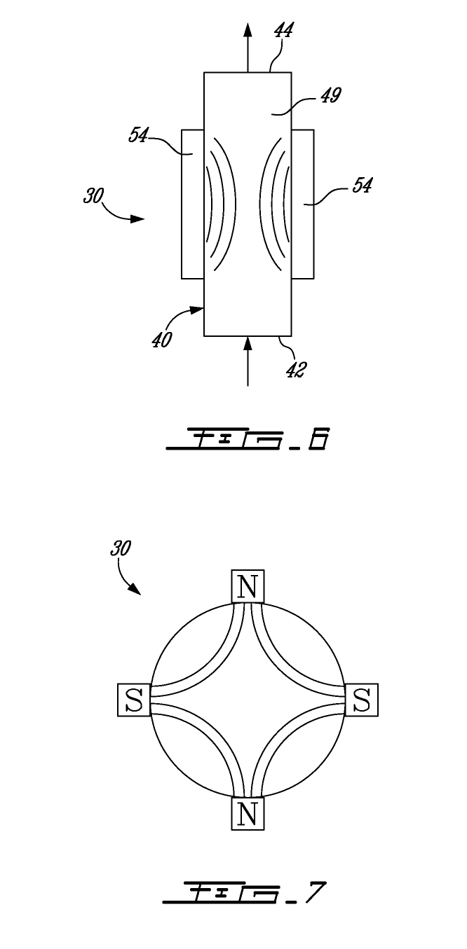

The apparatus 28 for treating carbon filamentary structures and preferably carbon nanotubes having metal particles attached or linked thereto, as shown in FIG. 4, comprises a housing (or elongated member) 40 defining a chamber 49, and having an inlet 42 and an outlet 44. The apparatus 28 also comprises a device 52 for generating a turbulent gas stream, preferably a supersonic gas stream in the chamber of the housing 40. The gas stream is represented by the horizontal arrow.

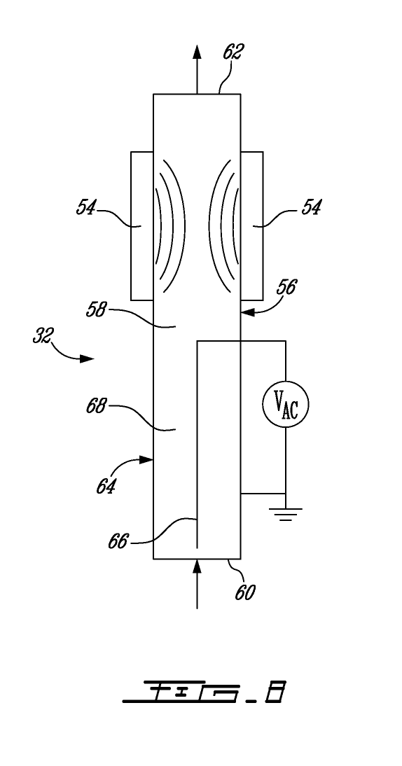

The apparatus 29 for treating carbon filamentary structures and preferably carbon nanotubes having metal particles attached or linked thereto, as shown in FIG. 5, comprises a housing 51 defining a chamber 49. The apparatus 29 also comprises an inlet 42 and outlet 44. A coil 55 is disposed around the housing 51 and is used for generating a time variable magnetic field, preferably an AC magnetic field, in the chamber 49 by applying the appropriate voltage on the coil. The gaseous phase containing the carbon filamentary structures (preferably nanotubes) and the metal particles is submitted to a disturbance generated by the apparatus 29 when it passes through the chamber 49. The time variable magnetic field permits to at least partially separate nanotubes from metal particles by applying a time variable magnetic force on the magnetic particles but also by inducing a current, which preferentially heats the interface between the nanotubes and the metal particles because of their higher resistance.

In system 9 (FIG. 1) when the apparatus 24, 26, 28, or 29 (FIGS. 2 to 5) is used, the gaseous phase comprising carbon filamentary structures and preferably carbon nanotubes and metal particles is first introduced in the inlet 42 of one of theses apparatuses before passing through the chamber 49 of the housing. Then, the gaseous phase is submitted to a disturbance in order to physically separate at least a portion of the carbon nanotubes from the metal particles in the gaseous phase. Therefore, it increases the proportion of carbon nanotubes that are not linked nor attached to metal particles. In the apparatus 24 (FIG. 2), the disturbance is a caused by a time variable electric field, (preferably an AC electric field). In the apparatus 26 (FIG. 3) the disturbance is caused by ultrasounds and in apparatus 28 (FIG. 4), it is caused by a turbulent gas stream, preferably a supersonic gas stream. In apparatus 29 (FIG. 5) the disturbance is caused by a time variable magnetic field, preferably an AC magnetic field. As example, a disturbance caused by an electric field will induce in carbon nanotubes such as single-wall carbon nanotubes an electric dipole, which will generate a rotation torque. When such an electric dipole is present in an electric field, the torque will cause the dipole to rotate around its mass center in order to align it with the direction of the electric field. At frequency preferably above 1 KHz, the strong shaking induced can result in the physical separation of the nanotubes and the magnetic metal particles. After having been treated with such apparatuses (24, 26, 28, or 29) the desired carbon filamentary structures can be purified in various manners by removing therefrom the metal particles which have been at least partially physically separated therefrom. Various techniques using chemicals can be used. Also purification can advantageously be carried out directly to the gaseous phase as defined in the present invention. It is also possible to use the combination of two different disturbance generators selected from the group consisting of apparatuses 24, 26, 28, and 29 in order to at least partially separate the desired carbon filamentary structures from the metal particles. The methods and apparatuses of the present invention are efficient for separating magnetic metal catalysts as well as non-magnetic metal catalyst from the carbon filamentary structures.

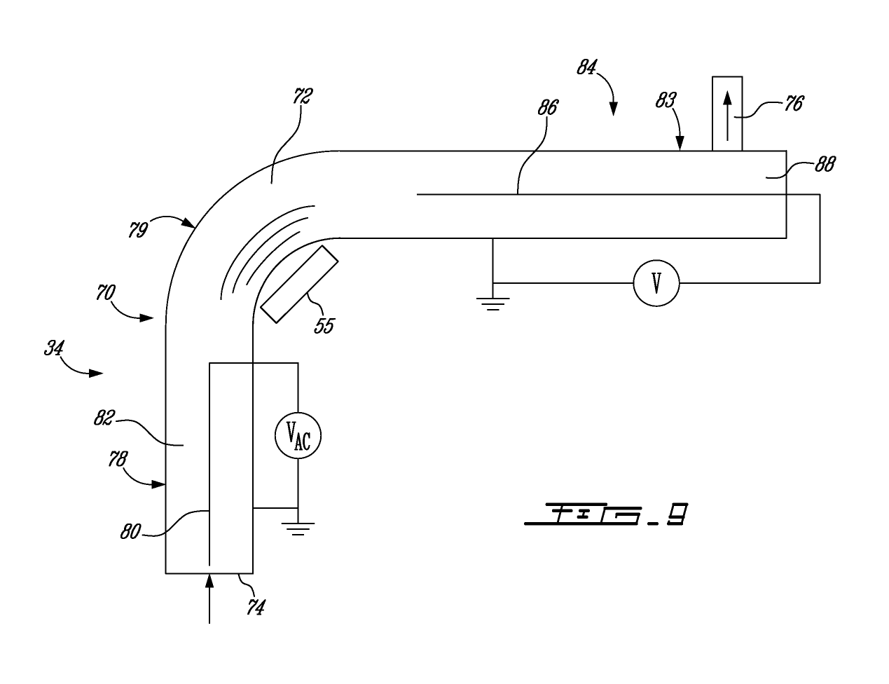

The apparatus 30 for purifying carbon filamentary structures (preferably carbon nanotubes) and shown in FIGS. 6 and 7, comprises a housing (or elongated member) 40 having a chamber 49, an inlet 42 and an outlet 44. The apparatus 30 also comprises permanent magnets 54 for generating an inhomogeneous magnetic field with a radial gradient, which is represented by curved lines. In FIG. 7, a cross sectional view of the apparatus is shown with a representation of the configuration of the inhomogeneous magnetic field between the magnets.

When a gaseous phase comprising carbon nanotubes and magnetic metal particles is introduced in the apparatus 30, preferably single-wall carbon nanotubes, in which at least a portion of them are substantially physically separated from the magnetic metal particles or at least weakly linked thereto, the gaseous phase is submitted to the inhomogeneous magnetic field generated by the permanent magnets 54. The majority of the magnetic metal particles free of carbon filamentary structures and/or coated with carbon is thus attracted and trapped by magnets while an important portion (preferably at least the major portion) of carbon nanotubes (free of metal or not) pass through the chamber 49 and are exited via the outlet 44 because of their higher inertia. Thus, the amount of magnetic metal particles in the gaseous phase is reduced. Moreover, the ratio magnetic metal particles:carbon filamentary structures is also reduced in view of the reasons previously mentioned. The portion of magnetic metal particles attracted by the magnets will depend on the intensity of the inhomogeneous magnetic field, the residence time of the particles in the purification apparatus, the metal concentration, the degree of separation between nanotubes and magnetic metal particles, etc. The apparatus 30 can be disposed downstream of an apparatus selected from the group consisting of apparatuses 24, 26, 28, 29, and mixtures thereof. The apparatus 30 can also be disposed directly downstream of an apparatus for producing carbon filamentary structures.

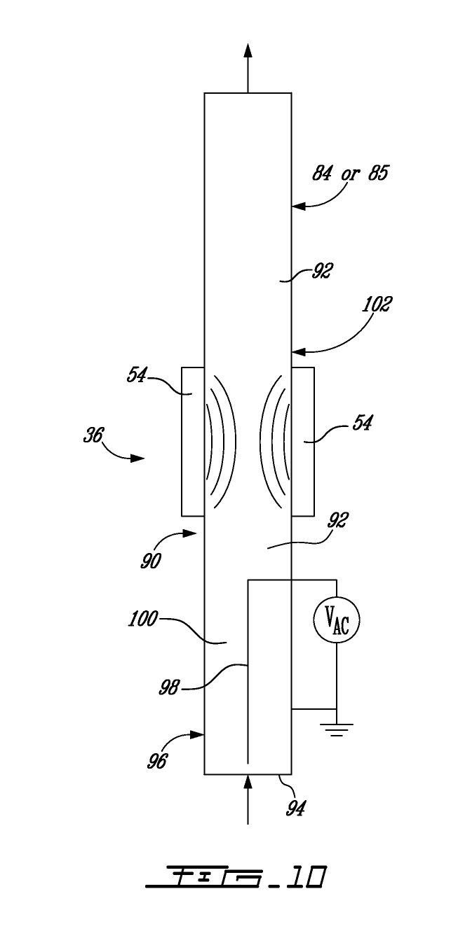

The apparatus 32 for purifying carbon filamentary structures and preferably carbon nanotubes, as shown in FIG. 8, comprises a housing (or elongated member) 56 having a chamber 58, an inlet 60 and an outlet 62. The lower portion of the housing 64 acts has a first electrode and a second electrode 66 is inserted through the chamber 58 of the housing 56. The electrodes 64 and 66 are spaced-apart and a space 68 is defined therebetween. Electrodes 64 and 66 can be in substantially parallel relationship and preferably in parallel relationship. More preferably, they are substantially coaxially aligned. A time variable voltage difference, preferably an AC voltage difference, is applied between electrodes 64 and 66. The upper portion of the housing 56 is provided with magnets 54 for generating an inhomogeneous magnetic field with a radial gradient, which is represented by curved lines. In the apparatus 32, the lower portion of the housing can be replaced with an apparatus similar to the apparatus 26, 28, 29, or 30 instead of an apparatus similar to apparatus 24 as shown in FIG. 8.

When a gaseous phase comprising carbon filamentary structures (preferably carbon nanotubes) and magnetic metal particles is introduced in the apparatus 32 (FIG. 8), the gaseous phase is submitted to the electric field generated between the electrodes 64 and 66 and thus, at least a portion of the carbon nanotubes can be substantially separated from the magnetic metal particles, as described above for FIG. 2, in view of the disturbance generated by the electric field. Then, the gaseous phase comprising carbon nanotubes substantially separated from the magnetic metal particles is submitted to the inhomogeneous magnetic field generated from the magnets 54. As described for the apparatus 30 of FIG. 6, a portion of the magnetic metal particles is thus attracted and trapped by magnets while an important portion of the carbon nanotubes pass through the chamber 58 and are exited via the outlet 62. Thus, the amount of magnetic metal particles in the gaseous phase is reduced. Moreover, the ratio magnetic metal particles:carbon filamentary structures is also reduced. The proportion of magnetic metal particles attracted by the magnets 54 will depend on the intensity of the inhomogeneous magnetic field, the residence time of the particles in the purification apparatus, the metal concentration, the degree of separation between nanotubes and magnetic metal particles, etc. For a better efficiency of the apparatus 32 (yield obtain of purified carbon filamentary structures), it is preferable to obtain a good separation of the carbon nanotubes and magnetic metal particles when submitted to the electric field otherwise, some carbon nanotubes can be attracted and trapped together with the magnetic metal particles in the inhomogeneous magnetic field.

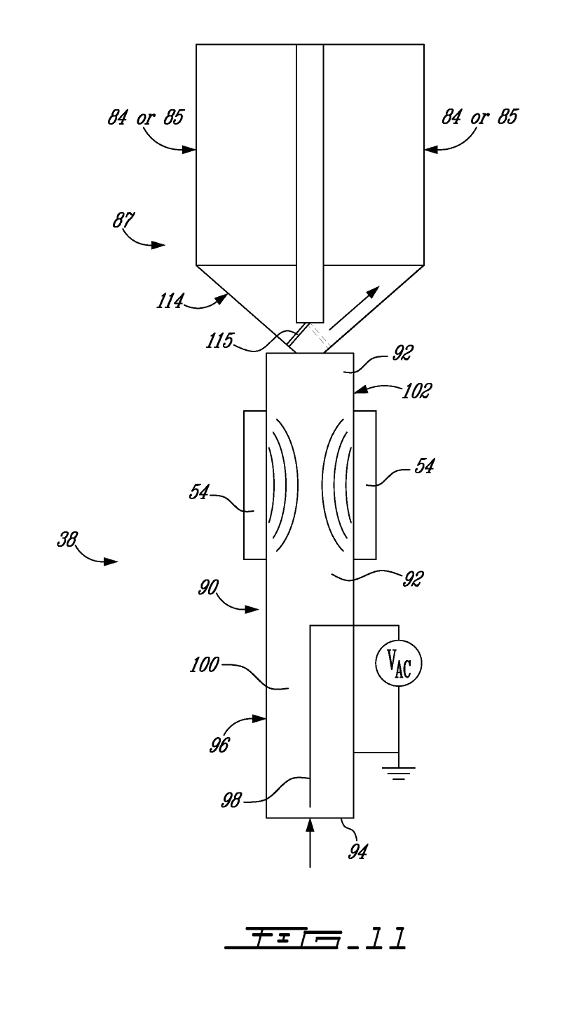

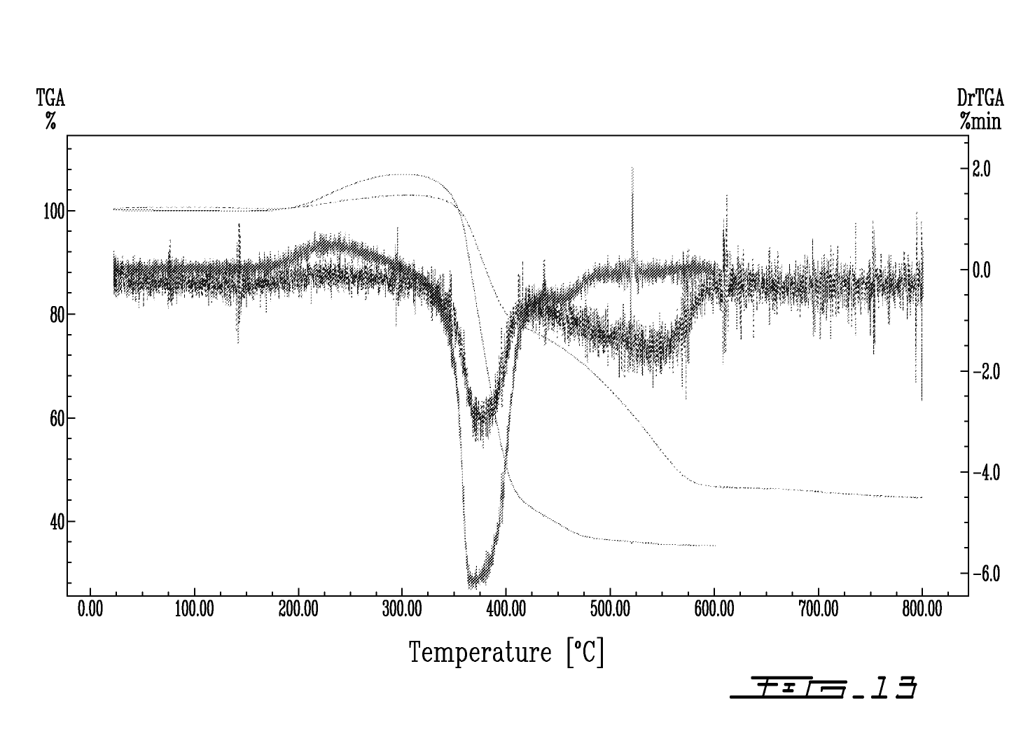

In FIG. 9, the apparatus 34 for purifying carbon filamentary structures comprises a housing 70 defining a chamber 72, and having an inlet 74 and an outlet 76. The lower portion 78 of the housing 70 acts as a first electrode and a second electrode 80 is inserted through the lower portion 78 of the chamber 72 of the housing 70. The electrodes 78 and 80 are spaced-apart and a space 82 is defined therebetween. Electrodes 78 and 80 are in substantially parallel relationship and preferably in parallel relationship. More preferably, they are substantially coaxially aligned. A time variable voltage difference, preferably an AC voltage difference is applied between electrode 78 and 80. The curved portion 79 of the housing 70 is provided with permanent magnet(s) 55 for generating an inhomogeneous magnetic field with a radial gradient, which is represented by curved lines. In the cross-section schematic view of FIG. 9, only one magnet is shown but it will be understood that several magnets can be used depending on their form and depending on the magnetic field required. The upper portion 83 of the housing 70 is provided with a depositing unit (or device) 84 for recovering or depositing carbon nanotubes. The lower portion 78 of the housing 70 is in fluid flow communication with the curved portion 79, which is in fluid flow communication with the upper portion 83. A depositing unit 84 comprises two electrodes. The first electrode being the upper portion 83 of the housing 70 and the second electrode being electrode 86. The electrodes 83 and 86 are spaced-apart and a space 88 is defined therebetween. Electrodes 83 and 86 can be in substantially parallel relationship and preferably in parallel relationship. More preferably, they are substantially coaxially aligned. A Direct Current (DC) voltage difference is applied between electrode 83 and 86. In the apparatus 34, the lower portion of the housing can be replaced with an apparatus similar to the apparatus 26, 28 or 29 instead of an apparatus similar to apparatus 24 as presently showed in FIG. 9. Moreover, the electrode 80 can be a rotated electrode as shown in FIG. 12. In the apparatus 34, the device 84 can be replaced with a device 85 as shown in FIG. 12 in order to have a rotating electrode or a device 87 as shown in FIG. 11 in order to permit more easily a continuous purification of the carbon filamentary structures. The depositing device can be in fact one as those described in U.S. 60/664,953 filed on Mar. 25, 2005, which is hereby incorporated by reference in its entirety.

When a gaseous phase comprising carbon nanotubes and magnetic metal particles is introduced in the apparatus 34 (FIG. 9), the gaseous phase is submitted to the electric field generated by the electrodes 78 and 80 and thus the carbon nanotubes can be substantially separated or at least partially separated from the magnetic metal particles, as described above for FIG. 2, in view of the disturbance generated by the electric field. In fact, at least a portion of the nanotubes having metal particles attached or linked thereto will be separated from these metal particles after being submitted to such a disturbance. Then, the gaseous phase including an important portion of carbon nanotubes substantially separated from the magnetic metal particles is submitted to the inhomogeneous magnetic field generated from the permanent magnets 55. A combination of the centrifugal force and the inhomogeneous magnetic field thus acts on the magnetic metal particles in order to attract and subsequently trap them on the wall while the carbon nanotubes having a higher mass and inertia pass through the chamber 72 before reaching the upper portion 83 of the housing 70 or the depositing unit 84, where the nanotubes are deposited on the electrode 86. Such a curved portion 79 permits to combine the effects of centrifugal force and the inhomogeneous magnetic field, thereby permitting to trap higher amounts of magnetic metal particles. Thus, the gaseous phase entering in the depositing unit 84 has a considerably reduced amount of magnetic metal particles. In fact, the ratio metal particles:carbon filamentary structures is considerably reduced in the gaseous phase after the treatment in the portions 78 and 79 of the apparatus 34. It thus permits to recover nanotubes having a satisfactory purity that are deposited on the electrode 86.

The carbon nanotubes, when entering in the unit 84 of FIG. 9, they are submitted to the electric field generated between the electrodes 83 and 86, and will be deposited on the electrodes, preferably on the inner electrode (electrode 86) since it can be rotated as shown in FIG. 12. At the beginning of the process, the current is almost non-existent since no ionized particles are suspended in the gaseous phase. The carbon nanotubes and preferably single-wall carbon nanotubes can be polarized and ionized when submitted to the electric field. Then, these particles will undergo an aggregation process in the gas-phase of the space 88 in order to form long filaments of an entanglement of nanotubes that can be rolled up around the electrode when the latter is a rotating electrode as shown in FIG. 12. This filaments formation is caused by the high aspect ratio (length/diameter) and the nanometric dimensions of carbon nanotubes, especially single-wall carbon nanotubes and multi-wall carbon nanotubes. It is thus strongly enhancing the local electric field existing at the tip or the surface of the nanotubes, which permit the easy emission of electrons because of the field or Shottky emission effect. When the carbon filamentary particles are gradually deposited on electrode 86, the electric field and electron flow increase in view of the field or Shottky emission effect. The local electric field becomes large enough for a breakdown at the tip of these particles, and an avalanche thus occurs and propagates to form macroscopic assemblies of nanotubes, that eventually form filaments of such macroscopic assemblies. The plurality of filaments then forms an entanglement that has a web-like structure or configuration. Such an entanglement or web-like structure comprises nanotubes and their aggregates which are entangled and linked together by electrostatic and polarization forces. The web of single-wall carbon nanotubes can be seen as the result of the electrical discharge between electrodes; it will thus have the same structure as the electrical streamers of the discharge. The particles comprised in the gaseous flow that are not deposited will be exited from the apparatus 34 by means of the outlet 76. Such an outlet can also comprise a filter (not shown) that prevents emissions of dangerous particles. The carbon nanotubes thus deposited on electrode 86 are purified. It will be understood by the person skilled in the art that the purity level of the deposited carbon nanotubes will depend on the quality of the separation of the carbon nanotubes and magnetic metal particles brought in the lower portion of the apparatus as well as on the efficiency of the inhomogeneous magnetic field generated in the curved portion caused to trap the magnetic metal particles.

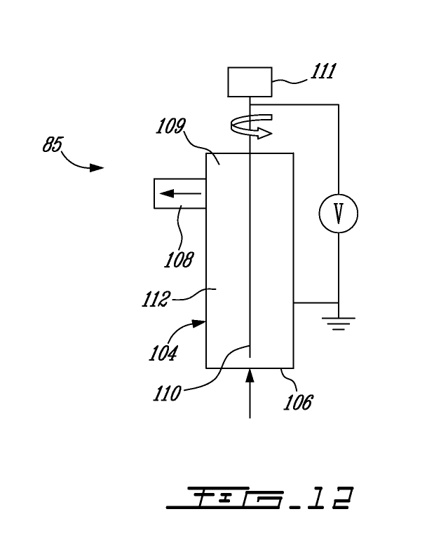

In FIG. 10, the apparatus 36 for purifying carbon filamentary structures is similar to the apparatus 34 of FIG. 9 with the exception that it has an elongated shape instead of a curved shape. The apparatus 36 comprises a housing 90 having a chamber 92 and an inlet 94. The lower portion 96 of the housing 90 acts as a first electrode and a second electrode 98 is inserted through the lower portion of the chamber 92 of the housing 90. The electrodes 96 and 98 are spaced-apart and a space 100 is defined therebetween. Electrodes 96 and 98 can be in substantially parallel relationship and preferably in parallel relationship. More preferably, they are substantially coaxially aligned. A time variable voltage difference, preferably an AC voltage difference is applied between electrode 96 and 98. The middle portion 102 of the housing 90 is provided with permanent magnets 54 for generating an inhomogeneous magnetic field with a radial gradient, which is represented by curved lines. The upper portion of the housing is provided with a depositing unit (or device) 84 (FIG. 9) or 85 (FIG. 12) for depositing carbon nanotubes. The device 85 is particularly preferred. Such a depositing unit 85 is detailed in FIG. 12. The depositing unit 85 comprises a housing 104, an inlet 106 and an outlet 108. The housing also has a chamber 109. The housing 104 act as a first electrode and a second electrode 110 is inserted in the chamber. The electrodes 104 and 110 are spaced-apart and a space 112 is defined therebetween and inside the chamber 109. Electrodes 104 and 110 can be in substantially parallel relationship and preferably in parallel relationship. More preferably, they are substantially coaxially aligned. A Direct Current (DC) voltage difference is applied between electrode 104 and 110. The electrode 110 is provided with a motor 111, which imparts a rotation to the latter.

When a gaseous phase comprising carbon nanotubes and magnetic metal particles is introduced in the apparatus 36 (FIG. 10), the gaseous phase is submitted to the electric field generated between the electrodes 96 and 98 and thus the carbon nanotubes can be substantially separated from the magnetic metal particles, as described above for FIG. 2, in view of the disturbance generated by the electric field. Then, the gaseous phase is submitted to the inhomogeneous magnetic field with a radial gradient generated from the permanent magnets 54. This substantially reduces the amount of magnetic metal particles in the gaseous phase as previously indicated for the apparatus 30 showed in FIG. 6. Finally, the carbon nanotubes will be deposited on electrode 110 of the apparatus 85 (FIG. 12) as it has been described for the unit 84 of the apparatus 34 of FIG. 9. However, in the present case, the electrode 110 is rotated so as to roll up the carbon filamentary structures.

Since the deposited carbon nanotubes have tendency to bridge electrodes 104 and 110 in FIG. 12 and eventually, over a certain period of time, clog the passage therebetween (space 112), the electrode 110 is preferably rotated in order to permit a continuous operation. The rotation of electrode 110 will cause the structures to be rolled up around electrode 110, thus preventing the deposit to bridge the electrodes and eventually clog the space 112. Such a rolled up configuration is similar to cotton candy. The deposit also has a foamy aspect.

The apparatus 38 shown in FIG. 11 is similar to the apparatus 36 shown in FIG. 10 with the exception that the depositing unit 85 is replaced with an apparatus 87 including distributing device 114 having two depositing units 84 or 85 (see FIGS. 9 and 12) and a valve 115 for selectively feeding one of the depositing units with the gaseous phase. The apparatus 38 is preferably provided with two units 85. It can also comprise more than two depositing units. In fact, it preferably comprises at least two depositing units. The apparatus 38 also comprises a housing 90 defining a chamber 92 and an inlet 94. The lower portion 96 of the housing 90 acts as a first electrode and a second electrode 98 is inserted through the lower portion of the chamber 92 of the housing 90. The electrodes 96 and 98 are spaced-apart and a space 100 is defined therebetween. Electrodes 96 and 98 can be in substantially parallel relationship and preferably in parallel relationship. More preferably, they are substantially coaxially aligned. A time variable voltage difference, preferably an AC voltage difference is applied between electrode 96 and 98. The middle portion 102 of the housing 90 is provided with magnets 54 for generating an inhomogeneous magnetic field with a radial gradient, which is represented by curved lines. The upper portion of the housing is provided with the apparatus 87 that includes the distributing device 114. The gaseous phase passes through the apparatus 38 in the same manner than in apparatus 36 showed in FIG. 10.

However, with the apparatus 38 of FIG. 11, the synthesis and/or purification of carbon nanotubes can be carried out in a continuous manner in view of the distributing device 114. When the gaseous phase is introduced in the distributing device 114, it can be selectively directed in any one of the depositing units 84 or 85 by means of the valve 115. As example, when the gaseous phase is fed into one of the unit 85 for depositing carbon nanotubes therein, the electric voltage difference in the other unit (84 or 85) is turned off and the carbon nanotubes deposited on its electrode(s) can be recovered. In such a case, as example when using a unit 85, the motor 111 and electrode 110 can be removed from the unit 85. When this step is completed, this unit 85 can be used again for depositing carbon nanotubes. The deposit is thus performed in each unit 85 alternatively.

It should be noted that the apparatuses shown in FIGS. 2 to 11 can be used downstream of any device that permits to produce carbon filamentary structures. If a device for producing carbon filamentary structures does not produce such structures by means of a gas phase synthesis, it is possible to recuperate the carbon filamentary structures and insert them in a gas phase so as to use the methods and apparatuses described in the present invention. It should also be noted that the apparatuses of FIGS. 2 to 8, can be disposed upstream of a depositing units or devices as shown as shown in FIGS. 9, 11 and 12.

### EXAMPLES

The following examples represent only preferred embodiments of the present invention.

An experiment was carried out by using an apparatus for purifying carbon nanotubes according to a preferred embodiment of the invention. For this experiment, an apparatus similar to the one schematically represented in FIG. 10 was used without the action of the disturbance generator in order to verify the efficiency of the apparatus and more particularly the efficiency of the process when the carbon filamentary structures are only submitted to the action of the inhomogeneous magnetic field. It was in fact the equivalent of using the apparatus of FIG. 6. The apparatus for purifying nanotubes was used downstream of a plasma torch for producing single-wall carbon nanotubes. In order to study its effect, deposits on the wall and downstream of the apparatus have been collected. The plasma torch used was similar to the plasma torch represented in FIG. 1 of US 2003/0211030, which is hereby incorporated herein by reference in its entirety. The inert gas used for generating the primary plasma was argon, the metal catalyst was ferrocene, the carbon-containing gas was ethylene and the cooling gas was helium. Helium was also injected toward the plasma discharging end for preventing carbon deposit. Ferrocene was heated to about 80° C. prior to be injected. The argon flow varied was about 3200 sccm (standard cubic centimeters per minute). The helium flows were both stabilized at about 3250 sccm, and the ethylene flow was about 60 sccm. The temperature of the oven was kept at about 1000° C. and measured with a thermocouple. The power of the source generating the electromagnetic radiations (microwaves) was 1500 W and the reflected power was about 200 W. The heat-resistant tubular members were made of quartz. The plasma tube was made of boron nitride. The feed conduit was made of stainless steel. The metal catalyst (ferrocene) and the carbon-containing substance (ethylene) were used in an atomic ratio metal atoms/carbon atoms between 0.02-0.06. The experiment was carried out at atmospheric pressure with an in situ purification apparatus similar to the one of FIG. 10.

The purification apparatus was provided with eight rare earth (NdFeB) permanent magnets of 0.4 Tesla disposed symmetrically in a protective coating (not shown), with a length and diameter of respectively 12 and 10 cm, in order to generate a strong inhomogeneous magnetic field with a radial gradient, i.e. perpendicular to the flow of gas (see FIGS. 6 to 8) containing the single-wall carbon nanotubes, the iron catalyst particles and the other forms of carbon. By using such permanent magnets, it was possible to substantially selectively attract large catalyst particles surrounded with graphitic shells. The deposit obtained on the wall of the purification apparatus was indeed only found on the surface occupied by the rectangular magnets and could reach up to about 10% to 15% by weight based on the total weight of the deposit. The magnetic field configuration used was similar to that of FIG. 7. The gas flow carrying the synthesized particles was confined in the center of the flow to produce a smoke stream centered in the gas flow. It thus prevented the synthesized particles to directly be in contact with the surface of the protective coating containing the magnets. The attracted particles had thus to drift from the center of the apparatus to the wall before being trapped by the magnet magnetic field. Therefore, it was possible to avoid attracting most of the iron nanoparticles attached or linked to carbon nanotubes since they possess a higher inertia as compared to free metal particles. It would have required a longer residence time in the purification apparatus before they could have been significantly trapped. The confinement of the smoke in the gas flow had a similar effect to the use of a centrifugal force in combination with a magnetic force. It is aimed to increase the attraction selectivity towards the isolated iron nanoparticles covered of a carbon coating as compared to carbon filamentary structures attached or linked to magnetic metal particles.

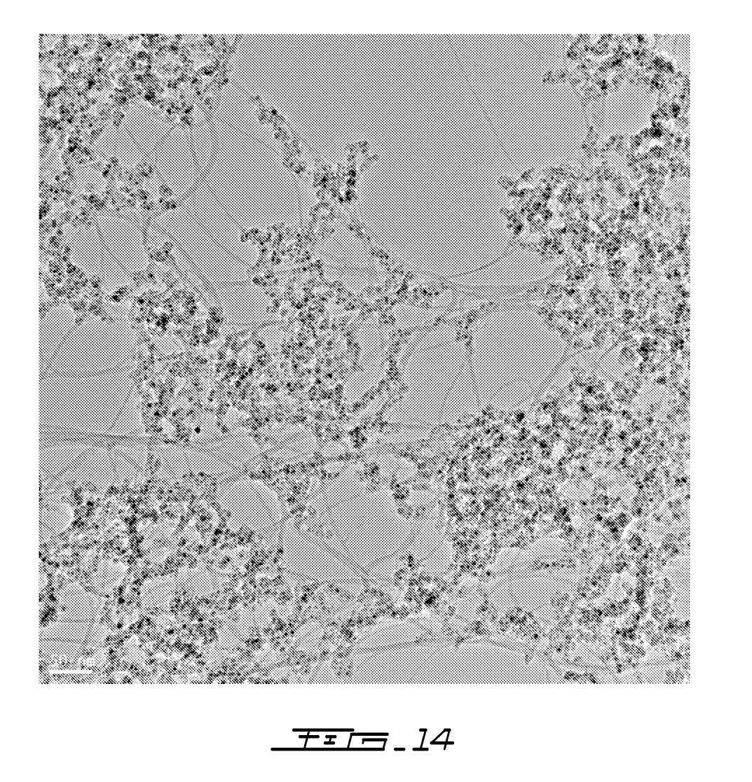

The thermogravimetric analysis (TGA) graph shown in FIG. 13 compares the deposit treated with the purification apparatus (plain line) and recovered in the depositing unit with the deposit obtained on the magnets (dashed line). Their derivatives are also superposed on the graph with their respective line type. The apparatus similar to the one of FIG. 10 was provided with a depositing device or unit similar to unit 85 shown in FIG. 12. Thus, the deposit of carbon filamentary structures was treated and then recovered downstream of the purification apparatus, with a depositing device similar to the device 85 as shown in FIG. 12. The TGA graph clearly demonstrates the difference in the composition of the deposit on the magnets and the deposit in the depositing device. The deposit on the magnets had a quite different oxidation behavior and an ashes content of 45% instead of 35% for the purified deposit recovered from the depositing unit. The ashes content plateau is correlated to the amount of remaining oxidized metal, which is mainly Fe₂O₃ and is composed of iron at about 70% by weight. Such a difference in the plateau thus indicates that the sample on the magnet has a higher relative content of metal with respect to the carbon as compared to the deposit recovered from the depositing unit. Such a purification was achieved by substantially selectively removing the metal catalyst nanoparticles coated with carbon that have not nucleated carbon nanotubes (that were not linked nor attached to carbon filamentary structures). In FIG. 13, the change in the slope just after 400° C. can be correlated to the oxidation of the graphitic shells of the catalyst nanoparticles, which have a higher oxidation temperature. It thus clearly indicates the significant increase of these catalyst particles in the deposit trapped on the magnets since this phase is predominant. In fact, more than 80% by weight of the deposit trapped on the magnets was a side product or undesired product (magnetic metal particles coated with graphitic or amorphous carbon) generated during the synthesis. Only about 1 or 2% by weight of the deposit trapped was carbon nanotubes, the remaining portion being metal particles.

Surprisingly, such a simple in situ purification technique using only an inhomogeneous field permitted to remove about 12% to about 14% by weight of impurities in the gaseous phase. In fact, an amount about 12% to about 14% by weight (based on the total weight of the unpurified gaseous phase) of undesired or side products such as amorphous or graphitic carbon and magnetic metal particles was removed. In other words, an amount of about 5% to about 7% by weight, based on the total weight of the unpurified gaseous phase, of magnetic metal particles was removed from the gaseous phase. It thus permitted to remove considerable amounts of carbon (such as graphitic carbon or amorphous carbon) that was not under the nanotube form, as well as magnetic metal particles. Some tests demonstrate that with a disturbance before the inhomogeneous field the carbon filamentary structures can have a higher degree of purity when such a disturbance is used.

In the experiment previously mentioned, an amount of about 400 mg of single-wall nanotubes was obtained in one hour and the purity was about 50% to about 60% by weight. When a similar experiment or synthesis is carried without the use of an apparatus for purifying carbon filamentary structures according to the present invention, the purity obtained is only of about 40% to about 50% by weight.

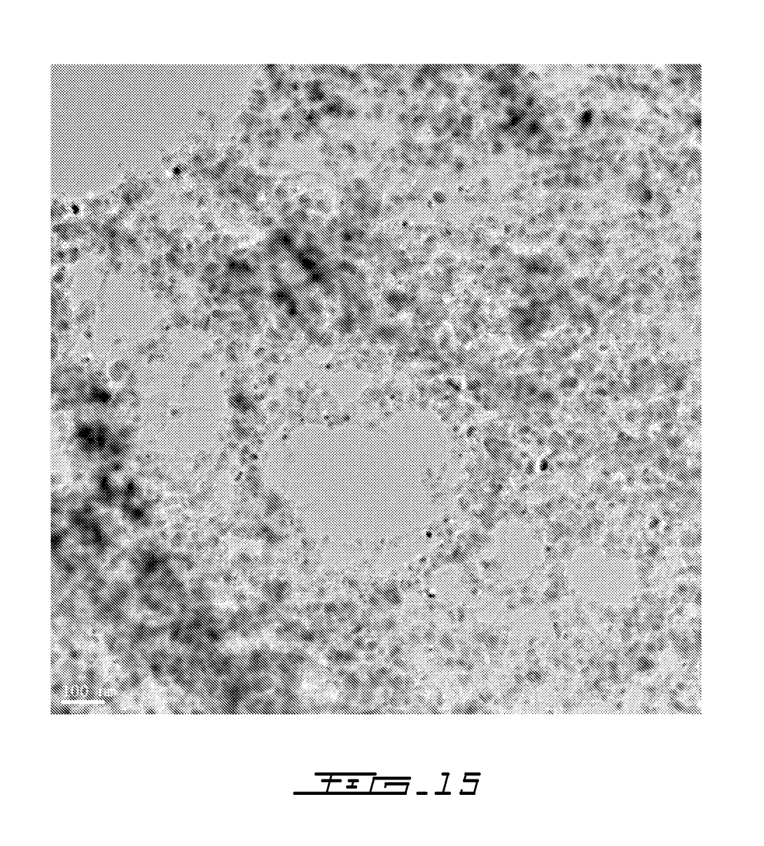

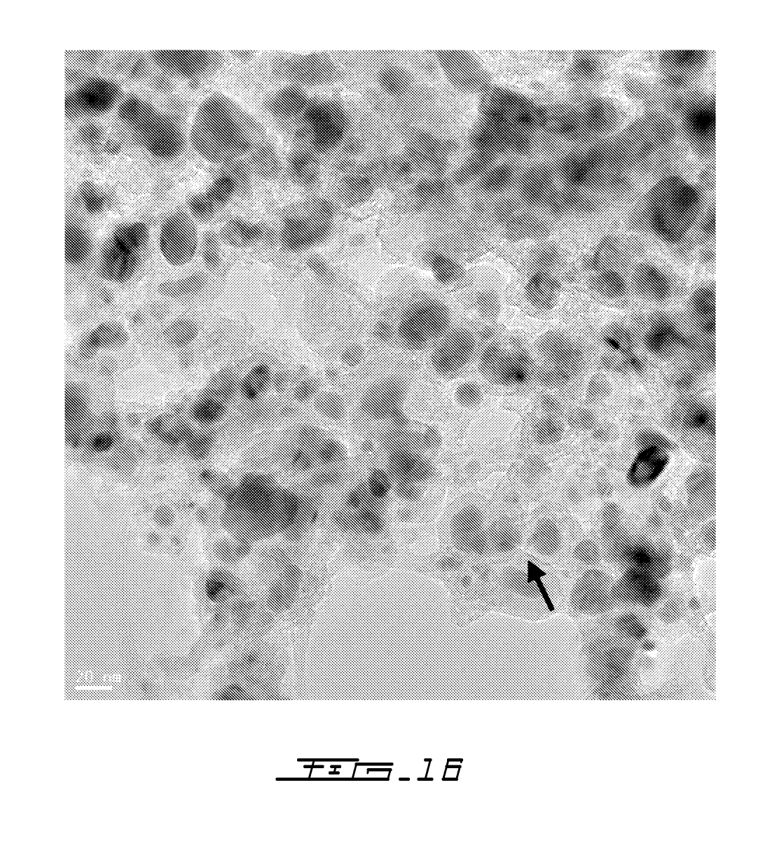

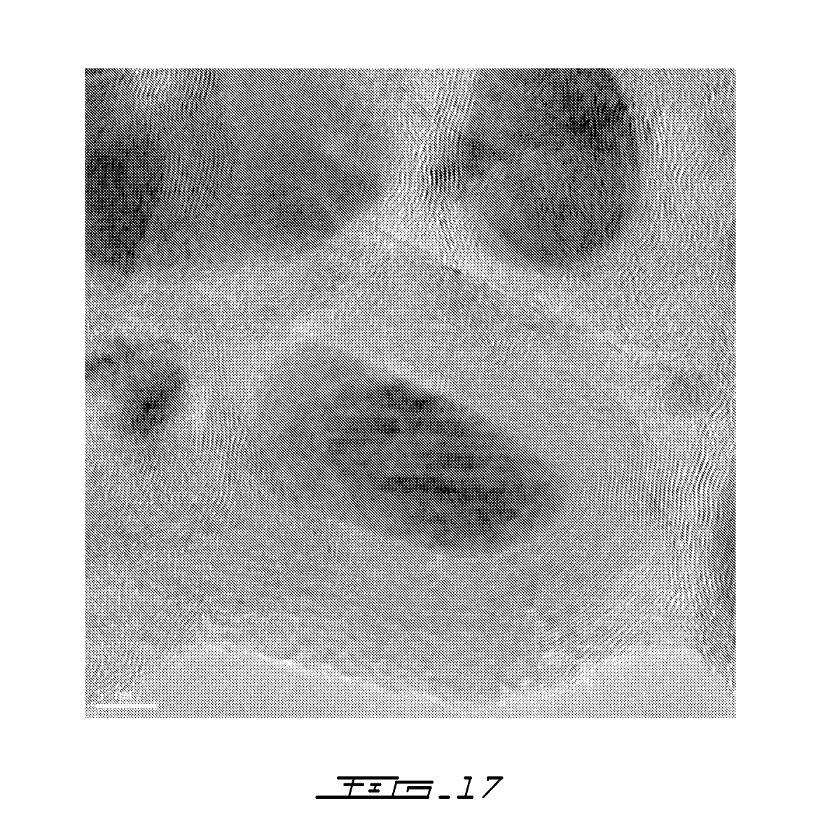

Transmission electron microscope (TEM) analyses were carried out on the deposit recovered on the permanent magnets and compared with the deposit of carbon filamentary structures recovered from the depositing apparatus in order to support these conclusions. In FIG. 14, the TEM analysis clearly shows the higher proportion of nanotubes contained in the purified carbon filamentary structures as compared to the TEM analysis of the deposit recovered adjacently to the magnets (see FIG. 15). The latter TEM analysis also shows the abundant presence of larger catalyst nanoparticles (diameter of about 10-20 nm) surrounded with graphitic shells and/or amorphous carbon and very few nanotubes as demonstrated in the TGA of FIG. 13. From FIG. 15, it can be seen that the majority of the carbon present in this sample (recovered from the magnet deposit) is not under the form of nanotubes but rather in the form of a coating on the magnetic metal particles. In FIG. 16, a higher magnification shows the structure of typical iron nanoparticles deposited adjacently to the permanent magnets while in FIG. 17, a zoom of the particle indicated with an arrow in the FIG. 16 reveals its graphitic shells.

While the invention has been described with particular reference to the illustrated embodiment, it will be understood that numerous modifications thereto will appear to those skilled in the art. Accordingly, the above description and accompanying drawings should be taken as illustrative of the invention and not in a limiting sense.

What is claimed is:

1. A method for treating a gaseous phase comprising single-wall carbon nanotubes having metal particles attached or linked thereto, for separating at least a portion of said single-wall carbon nanotubes from said metal particles, said method comprising submitting said gaseous phase to a disturbance generated by an electric field, a magnetic field, ultrasounds, a turbulent gas stream, or combinations thereof, thereby reducing the amount of single-wall carbon nanotubes having metal particles attached or linked thereto.

2. The method of claim 1, wherein said metal is selected from the group consisting of Co, Fe, Mo, Ni, Pd, Rh, Ru, Y, La, Ce and mixtures thereof.

3. The method of claim 1, wherein said metal is selected from the group consisting of Co, Fe, Ni, and mixtures thereof.

4. The method of claim 1, wherein said metal is Fe.

5. The method of claim 1, wherein said gaseous phase has a density of about 1×10² to about 1×10¹² single-wall carbon nanotubes per cm³.

6. The method of claim 1, wherein said gaseous phase has a density of about 1×10⁷ to about 1×10¹⁰ single-wall carbon nanotubes per cm³.

7. The method of claim 1, wherein said disturbance is an inhomogeneous magnetic field having a magnetic flux density ranging from about 0.001 to about 10 Tesla.

8. The method of claim 7, wherein said magnetic flux density ranges from about 0.1 to about 5 Tesla.

9. The method of claim 1, wherein said disturbance is an inhomogeneous magnetic field having a gradient ranging from about 0.01 to about 10 Tesla/m.

10. The method of claim 9, wherein said gradient ranges from about 0.1 to about 10 Tesla/m.

11. The method of claim 1, wherein said disturbance is an inhomogeneous magnetic field that is generated by a permanent magnet, an electromagnet, a solenoid, a coil or a combination of coils.

12. The method of claim 7, wherein said gaseous phase is further submitted to a centrifugal force while being submitted to the inhomogeneous magnetic field.

13. The method of claim 1, wherein said gaseous phase comprises a gas selected from the group consisting of He, Ar, H_{z}, H₂O, CO₂, CO, N₂, Kr, Xe, Ne and, mixtures thereof.

14. The method of claim 1, wherein said gaseous phase comprises helium, argon, or a mixture thereof.

15. An apparatus for purifying carbon filamentary structures contaminated with magnetic metal particles, said apparatus comprising:
a housing having a chamber dimensioned to receive a gaseous phase comprising said carbon filamentary structures contaminated with magnetic metal particles, an inlet and an outlet, said inlet and said outlet being in fluid flow communication with said chamber; and
an inhomogeneous magnetic field generator disposed inside or adjacent to said chamber, said magnetic field generator being adapted to at least partially trap said magnetic metal particles in order to reduce the amount of magnetic metal particles present in said gaseous phase.

16. The apparatus of claim 15, wherein said inhomogeneous magnetic field generator is a permanent magnet, an electromagnet, a solenoid, a coil or a combination of coils.

17. The apparatus of claim 15, further comprising at least two electrodes disposed downstream of said inhomogeneous magnetic field generator in said chamber or adjacent thereto, said electrodes defining therebetween a space dimensioned to receive said gaseous phase comprising carbon filamentary structures, said electrodes being adapted to generate an electric field for depositing said carbon filamentary structures on at least one of said electrodes.

18. The apparatus of claim 15, further comprising a disturbance generator disposed inside or adjacent to said chamber and upstream of said inhomogeneous magnetic field generator, said disturbance generator being adapted to submit said gaseous phase to a disturbance in order to at least partially separate said carbon filamentary structures from said metal particles.

19. The apparatus of claim 18, wherein the disturbance generator comprises an alternative current (AC) or pulsed electric field generator, an AC or pulsed magnetic field generator, an ultrasounds generator, a turbulent gas stream, or combinations thereof.

20. The apparatus of claim 18, further comprising at least two electrodes disposed downstream of said inhomogeneous magnetic field generator in said chamber or adjacent thereto, said electrodes defining therebetween a space dimensioned to receive said gaseous phase comprising carbon filamentary structures, said electrodes being adapted to generate an electric field for depositing said carbon filamentary structures on at least one of said electrodes.
